(19) United States
(12) Patent Application Publication
(10) Pub. No.: US 2025/0232591 A1
(43) Pub. Date: Jul. 17, 2025

(54) AREA INFORMATION ESTIMATION METHOD AND SYSTEM AND NON-TRANSITORY COMPUTER READABLE STORAGE MEDIUM

(71) Applicant: HTC Corporation, Taoyuan City (TW)

(72) Inventors: Yi-Chen LIN, Taoyuan City (TW); Shi-Hao DONG, Taoyuan City (TW); Jia-Yau SHIAU, Taoyuan City (TW)

(21) Appl. No.: 18/415,615

(22) Filed: Jan. 17, 2024

(51) Int. Cl. G06V 20/52; G06T 7/70; G06V 10/82

(52) U.S. Cl. CPC G06V 20/53; G06T 7/70; G06V 10/82; G06T 2207/20084; G06T 2207/30196; G06T 2207/30232; G06T 2207/30242; G06T 2207/30244

(57) ABSTRACT

The present disclosure provides area information estimation method and system. The area information estimation system includes a processing device and a plurality of monitor devices. The area information estimation method includes: by the plurality of monitor devices, capturing a plurality of images of an area from different views; by the plurality of monitor devices, generating a plurality of two-dimensional (2D) density maps of at least one target object in the area according to the plurality of images; by the processing device, generating a three-dimensional (3D) density map according to the plurality of 2D density maps; and by the processing device, calculating a number of the at least one target object according to the 3D density map.

### BACKGROUND

### Field of Invention

This disclosure relates to a method and system, in particular to an area information estimation method and system.

### Description of Related Art

In the fields of crowd counting, some related arts perform the crowd counting based on single view. However, these related arts based on the single view may easily generate erroneous calculation results due to situations of crowding and/or occlusion, and thus are not suitable to estimate the number of people in a wide range area. Some related arts perform the crowd counting based on multiple views, and are usually implemented by a system including a computational unit and multiple cameras. However, these related arts based on the multiple views have to calibrate the cameras each time the camera changes its position, which is inconvenient for the user. In addition, the computational unit has to fuse outputs of the cameras together to further obtain final calculation results, which causes the heavy computational burden on the computational unit. Therefore, it is necessary to provide a new approach to perform the crowd counting.

### SUMMARY

An aspect of present disclosure relates to an area information estimation method applicable to an area information estimation system. The area information estimation system includes a processing device and a plurality of monitor devices. The area information estimation method includes: by the plurality of monitor devices, capturing a plurality of images of an area from different views; by the plurality of monitor devices, generating a plurality of two-dimensional (2D) density maps of at least one target object in the area according to the plurality of images; by the processing device, generating a three-dimensional (3D) density map according to the plurality of 2D density maps; and by the processing device, calculating a number of the at least one target object according to the 3D density map.

Another aspect of present disclosure relates to an area information estimation system. The area information estimation system includes a plurality of monitor devices and a processing device. The plurality of monitor devices are configured to be arranged in an area, are configured to capture a plurality of images of the area from different views, and are configured to generate a plurality of two-dimensional (2D) density maps of at least one target object in the area according to the plurality of images. The processing device is coupled to the plurality of monitor devices, is configured to generate a three-dimensional (3D) density map according to the plurality of 2D density maps, and is configured to calculate a number of the at least one target object according to the 3D density map.

Another aspect of present disclosure relates to a non-transitory computer readable storage medium with a computer program to execute an area information estimation method applicable to an area information estimation system. The area information estimation system includes a processing device and a plurality of monitor devices. The area information estimation method includes: by the plurality of monitor devices, capturing a plurality of images of an area from different views; by the plurality of monitor devices, generating a plurality of two-dimensional (2D) density maps of at least one target object in the area according to the plurality of images; by the processing device, generating a three-dimensional (3D) density map according to the plurality of 2D density maps; and by the processing device, calculating a number of the at least one target object according to the 3D density map.

It is to be understood that both the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of an area information estimation system arranged in an area in accordance with some embodiments of the present disclosure;

FIG. 2 is a block diagram of the area information estimation system in accordance with some embodiments of the present disclosure;

FIG. 3 is a flow diagram of an area information estimation method in accordance with some embodiments of the present disclosure; and

FIG. 4 is a schematic diagram of images, two-dimensional density maps, an aggregated volume model and a three-dimensional density map in accordance with some embodiments of the present disclosure.

### DETAILED DESCRIPTION

The embodiments are described in detail below with reference to the appended drawings to better understand the aspects of the present application. However, the provided embodiments are not intended to limit the scope of the disclosure, and the description of the structural operation is not intended to limit the order in which they are performed. Any device that has been recombined by components and produces an equivalent function is within the scope covered by the disclosure.

As used herein, “coupled” and “connected” may be used to indicate that two or more elements physical or electrical contact with each other directly or indirectly, and may also be used to indicate that two or more elements cooperate or interact with each other.

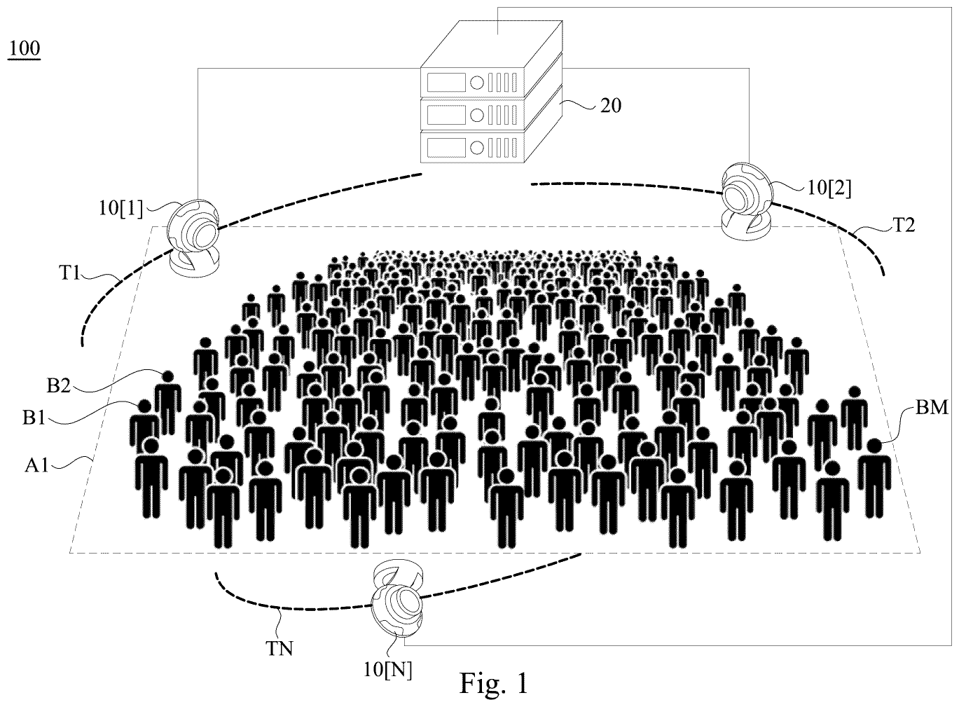

Referring to FIG. 1, FIG. 1 is a schematic diagram of an area information estimation system 100 in accordance with some embodiments of the present disclosure. In some embodiments, the area information estimation system 100 includes a plurality of monitor devices 10[1]-10[N] and a processing device 20, and is configured to obtain area information of an area A1. It should be understood that N can be an integer greater than 1. In some practical applications, the area information of the area A1 can be a traffic flow of a road, a population density of a space, number of people waiting for an entertainment equipment, etc.

In the embodiments of FIG. 1, the area information estimation system 100 is used to obtain number of multiple target objects B1 and B2-BM in the area A1, in which the target objects B1-BM each can be pedestrian, person, etc. It should be understood that M can be an integer greater than 1. In order to obtain the number of the target objects B1-BM, as shown in FIG. 1, the monitor devices 10[1]-10[N] are arranged to be evenly distributed in the area A1. Notably, each of the monitor devices 10[1]-10[N] is movable when being arranged in the area A1. For example, in FIG. 1, a trajectory T1 represents a path along which the monitor device 10[1] moves, a trajectory T2 represents a path along which the monitor device 10[2] moves, and a trajectory TN represents a path along which the monitor device 10[N] moves. The processing device 20 can be arranged in the area A1 or in another area (not shown) far away from the area A1. The processing device 20 is electrically and/or communicatively coupled to the monitor devices 10[1]-10[N]. In addition, the monitor devices 10[1]-10[N] are communicatively coupled to each other.

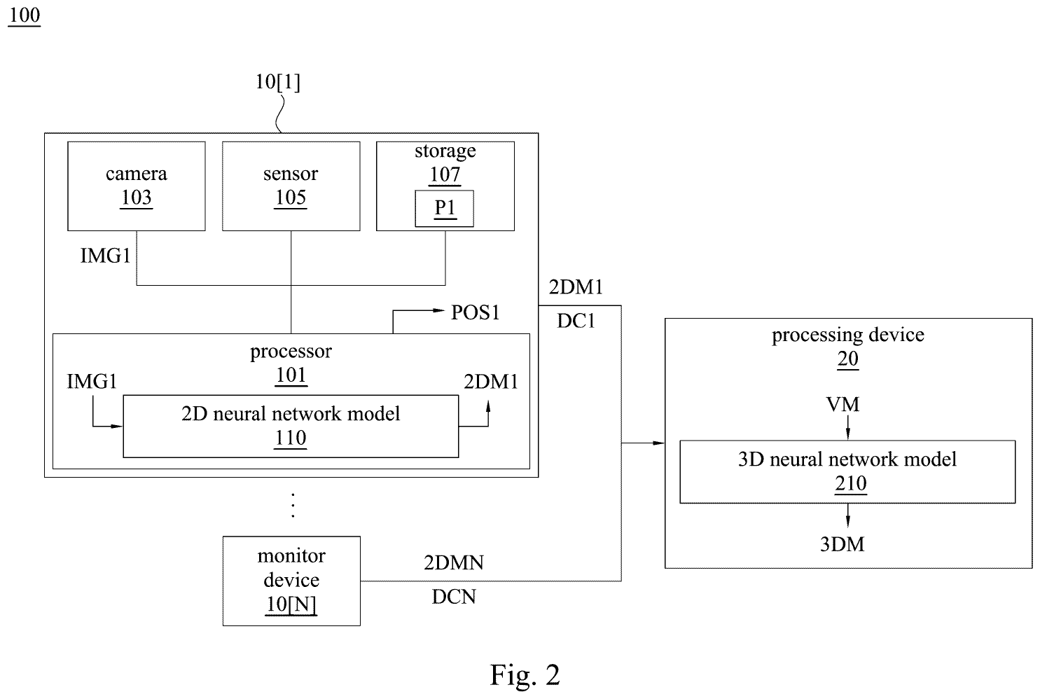

By the above described arrangements, the monitor devices 10[1]-10[N] can shoot from different views in the area A1, and can transmit (processed or unprocessed) signals, data and/or information from/to the processing device 20, so as to allow the processing device 20 to calculate the number of the target objects B1-BM. The operation of the monitor devices 10[1]-10[N] and the processing device 20 would be described in detail later. The structure of the monitor devices 10[1]-10[N] and the processing device 20 would be first described in detail below with reference to FIG. 2.

Referring to FIG. 2, FIG. 2 is a block diagram of the area information estimation system 100 in accordance with some embodiments of the present disclosure. It should be understood that the monitor devices 10[1]-10[N] may have the same structure. Thus, the structure of the monitor devices 10[1]-10[N] would be described by taking the monitor device 10[1] as an example. As shown in FIG. 2, the monitor device 10[1] includes a processor 101, a camera 103, a sensor 105 and a storage 107. The processor 101 is electrically coupled to the camera 103, the sensor 105 and the storage 107.

The camera 103 is configured to record and convert optical signals from the area A1 into electric signals, and can be implemented by at least one lens unit, a photosensitive element (i.e., image sensor such as complementary metal oxide semiconductor (CMOS), charge coupled device (CCD), etc.) and an image processor.

The sensor 105 is configured to generate and provide sense data. In particular, the sensor 105 can include tracking cameras and/or at least one inertial measurement unit (IMU), and the at least one inertial measurement unit can be implemented by accelerometer, magnetometer, gyroscope, etc. In some embodiments, the sense data can be used as auxiliary information for calculation of the processor 101, so as to improve operational performance of the processor 101. It should be understood that the sensor 105 is an optional component.

The storage 107 is configured to store signals, data and/or information required by the operation of the monitor device 10[1]. For example, the storage 107 may store camera parameter information P1 of the camera 103, the sense data sensed by the sensor 105, etc. The storage 107 can be implemented by at least one volatile memory unit, at least one non-volatile memory unit, or the both.

The processor 101 is configured to process signals, data and/or information required by the operation of the monitor device 10[1]. In some embodiments, the processor 101 can use at least one visual-based localization technology (e.g., Simultaneous Localization and Mapping (SLAM), etc.) to calculate pose of the monitor device 10[1] according to image data generated by the camera 103 and/or the tracking cameras in the sensor 105. In particular, the pose calculated by the processor 101 may indicate six degrees-of-freedom (6-DOF) of the monitor device 10[1]. Furthermore, the processor 101 can further use motion data generated by the at least one inertial measurement unit in the sensor 105 to help in calculating the pose of the monitor device 10[1], so as to increase the accuracy of the pose of the monitor device 10[1]. In some further embodiments, as shown in FIG. 2, the processor 101 utilizes a two-dimensional (2D) neural network model 110 to process. In particular, the 2D neural network model 110 can be a convolutional neural network (e.g, network for Congested Scene Recognition (CSRNet), multi-column convolutional neural network (MCNN), deep convolutional neural networks for cross-scene crowd counting, etc.) that has been well-trained to perform at least one specific task such as 2D image transform (which would be described in detailed later). The processor 101 can be implemented by central processing unit (CPU), graphic processing unit (GPU), application-specific integrated circuit (ASIC), microprocessor, system on a Chip (SoC) or other suitable processing units.

The processing device 20 is configured to process signals, data and/or information transmitted from the monitor device 10[1]. In some further embodiments, as shown in FIG. 2, the processing device 20 utilizes a three-dimensional (3D) neural network model 210 to process. In particular, the 3D neural network model 210 can be a convolutional neural network (e.g, fully convolutional neural networks for volumetric image segmentation (V-Net), Learning on Compressed Output (LoCO), U-shaped convolutional neural network (U-Net) transformers (UNETR), etc.) that has been well-trained to perform at least one specific task such as 3D model transform (which would be described in detailed later). The processing device 20 can be implemented by desktop computer, laptop computer, server, tablet, mobile phone, or other suitable computational apparatus.

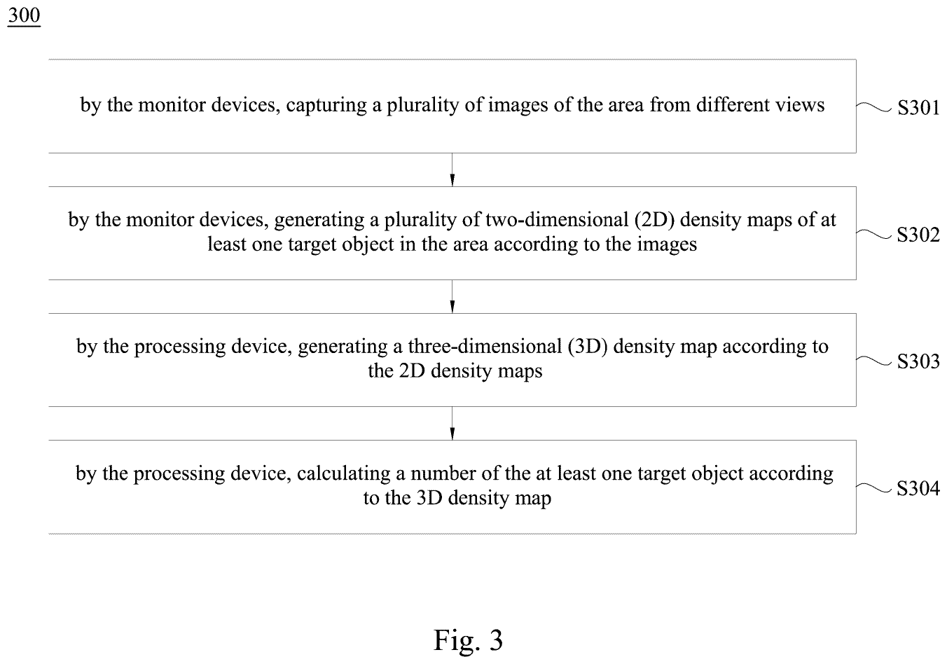

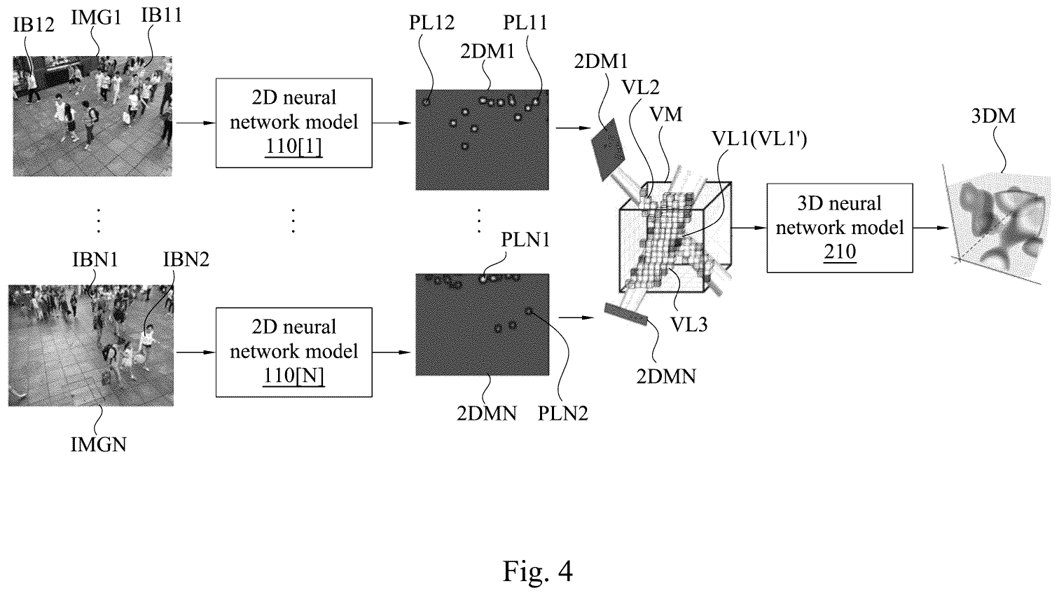

The operation of each element in FIG. 2 would be described in detail below with reference to FIGS. 3-4. Referring to FIG. 3, FIG. 3 is a flow diagram of an area information estimation method 300 in accordance with some embodiments of the present disclosure. The area information estimation method 300 is applicable to the area information estimation system 100 of FIGS. 1-2. In some embodiments, as shown in FIG. 3, the area information estimation method 300 includes operations S301-S304.

In operation S301, the monitor devices 10[1]-10[N] capture a plurality of images IMG1-IMGN of the area A1 from different views. In some embodiments, as shown in FIG. 1, the monitor device 10[1] can use the camera 103 in FIG. 2 to shoot the area A1 at a preset viewing direction of the camera 103, so that the camera 103 in FIG. 2 can generate the image IMG1 correspondingly. It should be understood that the others of the images IMG1-IMGN can be captured in the similar way as the image IMG1, and therefore the descriptions thereof are omitted herein.

In operation S302, the monitor devices 10[1]-10[N] generate a plurality of 2D density maps 2DM1-2DMN of at least one target object B1-BM in the area A1 according to the images IMG1-IMGN. In operation S303, the processing device 20 generates a 3D density map 3DM according to the 2D density maps 2DM1-2DMN. The above operations S302-S303 would be described in detail below with reference to FIG. 4.

Referring to FIG. 4, FIG. 4 is a schematic diagram of the images IMG1-IMGN, the 2D density maps 2DM1-2DMN, an aggregated volume model VM and the 3D density map 3DM in accordance with some embodiments of the present disclosure. In FIG. 4, the 2D neural network model 110[1] is the same as the 2D neural network model 110 in FIG. 2, the 2D neural network model 110[N] is belonged to the monitor device 10[N] in FIGS. 1-2, and the 2D neural network models of the others of the monitor devices 10[1]-10[N] are not shown for the convenience of descriptions.

In some embodiments of operation S302, as shown in FIG. 4, the monitor devices 10[1]-10[N] use the 2D neural network models 110[1]-110[N] to generate the 2D density maps 2DM1-2DMN according to the images IMG1-IMGN. In particular, the 2D neural network models 110[1]-110[N] may perform convolution operations on the images IMG1-IMGN, so as to generate the 2D density maps 2DM1-2DMN. As shown in FIG. 4, the 2D neural network model 110[1], which performs the convolution operations on the image IMG1, may recognize target portions IB11-IB12 (which may correspond to part of the target objects B1-BM in FIG. 1) from the image IMG1, and may predict the target portions IB11-IB12 with preset pixel value (e.g., the pixel value close to 1), so as to form characteristic pixel points PL11-PL12 on the 2D density map 2DM1. It should be understood that non-target portions (which may not correspond to anyone of the target objects B1-BM in FIG. 1) on the image IMG1 may be set to smallest pixel value (e.g., 0) significantly smaller than the preset pixel value, so as to form non-characteristic pixel portions on the 2D density map 2DM1. Similarly, the 2D neural network model 110[N], which performs the convolution operations on the image IMGN, may also transform target portions IBN1-IBN2 and non-target portions on the image IMGN into characteristic pixel points PLN1-PLN2 and non-characteristic pixel portions respectively, so as to form the 2D density map 2DMN. The others of the 2D density maps 2DM1-2DMN would be generated in the similar way as the 2D density maps 2DM1 and 2DMN in FIG. 4, and therefore the descriptions thereof are omitted herein.

As can be seen from FIG. 2 and the above descriptions of operation S302, in some embodiments, the processor 101 is configured to transform the image IMG1 into the 2D density map 2DM1 by using the 2D neural network model 110.

In some embodiments of operation S303, as shown in FIG. 4, the processing device 20 is configured to generate an aggregated volume model VM by projecting the 2D density maps 2DM1-2DMN, and is configured to generate the 3D density map 3DM according to the aggregated volume model VM. In some further embodiments, as shown in FIG. 2, the processing device 20 projects the 2D density maps 2DM1-2DMN according to a plurality of image capturing data DC1-DCN transmitted from the monitor devices 10[1]-10[N].

Because the generation of the image capturing data DC1-DCN might be deduced in analogy, the generation of the image capturing data DC1-DCN would be described by taking the image capturing data DC1 as an example. In some embodiments, as shown in FIG. 2, the processor 101 accesses the camera parameter information P1 stored in the storage 107 as the image capturing data DC1, and provides the image capturing data DC1 to the processing device 20. In particular, the camera parameter information P1 may include camera intrinsic, camera extrinsic and distortion coefficients. The camera intrinsic may indicate a projective transformation from a 2D image coordinate system to a camera coordinate system, and may be determined as soon as the camera 103 is manufactured. The camera extrinsic may indicate a rigid transformation from the camera coordinate system to a 3D world coordinate system, and may be determined according to one specific pose that the camera 103 of the monitor device 10[1] has after the monitor device 10[1] is arranged in the area A1. Also, the distortion coefficients indicate a calibration for a variety of lens distortions (e.g., radial distortion, tangential distortion, etc.), and may be determined as soon as the camera 103 is manufactured.

As can be seen from the above descriptions, the image capturing data DC1 may be used to indicate a relationship between the image IMG1 and a specific 3D space (e.g., the area A1) where the camera 103 of the monitor device 10[1] shoots. In brief, the image capturing data DC1-DCN are corresponding to the images IMG1-IMGN.

In accordance with the embodiments that the monitor devices 10[1]-10[N] are movable when being arranged in the area A1, the pose of the camera 103 may be changed when the monitor device 10[1] is moved. Accordingly, the camera extrinsic of the camera parameter information P1 should be updated when the monitor device 10[1] is moved. In some embodiments, as shown in FIG. 2, the monitor device 10[1] can utilize the processor 101 to generate device pose information POS1 for updating the camera extrinsic of the camera parameter information P1. In accordance with the above descriptions, the processor 101 can calculate the device pose information POS1 by the at least one visual-based localization technology. In other words, the device pose information POS1 may be the pose of the monitor device 10[1] (which can generally be regarded as the pose of the camera 103). Thus, the processor 101 can update the camera extrinsic of the camera parameter information P1 by the device pose information POS1, and can transmit the camera parameter information P1 (with the camera extrinsic being updated) as the image capturing data DC1 to the processing device 20. It can be seen from these that the processor 101 is configured to generate the image capturing data DC1 according to the device pose information POS1.

In some embodiments, based on the image capturing data DC1-DCN, the processing device 20 can obtain the position of each of the monitor devices 10[1]-10[N] in the area A1 in real-time.

In accordance with the embodiments that the 2D density maps 2DM1-2DMN are projected to generate the aggregated volume model VM, as shown in FIG. 4, a 3D cube related to the area A1 may be predefine as a frame of the aggregated volume model VM. In some embodiments, the processing device 20 is configured to calculate the position of each of the characteristic pixel points PL11-PL12 and PLN1-PLN2 of the 2D density maps 2DM1-2DMN in the aggregated volume model VM according to the image capturing data DC1-DCN. For example, by the camera intrinsic and the camera extrinsic in the image capturing data DC1, the processing device 20 may transform the characteristic pixel point PL11 of the 2D density map 2DM1 from the 2D image coordinate system to a 3D coordinate system (e.g., the 3D world coordinate system) applied by the aggregated volume model VM, and may use the pixel value of the characteristic pixel point PL11 as an voxel value of one voxel point VL1 at the transformed coordinate.

Similarly, the position of the characteristic pixel point PL12 of the 2D density map 2DM1 in the aggregated volume model VM may be calculated according to the image capturing data DC1, so as to form another voxel point VL2 of the aggregated volume model VM. Also, the position of the characteristic pixel points PLN1-PLN2 of the 2D density map 2DMN in the aggregated volume model VM may be calculated according to the image capturing data DCN, so as to form two voxel points VL1′ and VL3 of the aggregated volume model VM.

As shown in FIG. 4, in the aggregated volume model VM, the voxel point VL1 and the voxel points VL1′ may be overlapped with each other or may be at the same 3D coordinate. In this situation, the voxel value of the voxel point VL1 may be combined with the voxel value of the voxel points VL1′ to generate a much greater voxel value. However, this much greater voxel value may cause the processing device 20 to calculate an unacceptable result. For example, the voxel point VL1 and the voxel points VL1′ being at the same 3D coordinate may mean that the target portions IB11 and IBN1 corresponds to the same one of the target objects B1-BM, but the processing device 20 may calculate a number greater than 1 according to the much greater voxel value corresponding to the voxel point VL1 (and/or the voxel points VL1′).

In view of the above issues, the processing device 20 then uses the 3D neural network model 210 to transform the aggregated volume model VM into the 3D density map 3DM. In some embodiments, the 3D neural network model 210 may perform convolution operations on the aggregated volume model VM, so as to generate the 3D density map 3DM. In particular, the 3D neural network model 210, which performs the convolution operations on the aggregated volume model VM, may eliminate multiple overlapped voxel points (e.g., the voxel point VL1′ in FIG. 4) from the aggregated volume model VM, so as to form the 3D density map 3DM.

In operation S304, the processing device 20 calculates a number of the target objects B1-BM according to the 3D density map 3DM. In some embodiments, the processing device 20 performs at least one known counting approach on the 3D density map 3DM to calculate the number of the target objects B1-BM. For example, the processing device 20 can calculate the number of the target objects B1-BM by summing or integrating the voxel values within the 3D density map 3DM.

As can be seen from the descriptions of the above embodiments, the monitor devices 10[1]-10[N] should not be limited to the structure as shown in FIG. 2. For example, in some embodiments that the monitor devices 10[1]-10[N] are fixed in the area A1, the sensor 105 can be omitted from the FIG. 2. In some embodiments, the storage 107 can be integrated into the processor 101, so that the processor 101 can store the camera parameter information P1 and the storage 107 can be omitted from the FIG. 2. In brief, the structure of each of the monitor devices 10[1]-10[N] can be adjusted according to the practical requirements. Furthermore, any of the various calculations described in the above embodiments (e.g., generation of the 2D density maps 2DM1-2DMN, generation of the aggregated volume model VM, generation of the 3D density map 3DM, generation of the device pose information POS1, counting of the number of the target objects B1-BM, etc.) can be performed on the cloud computing environments or through other computational resources, so that the heavy computational burden can be shared among the monitor devices 10[1]-10[N], the processing device 20, and the cloud computing environments (or other computational resources).

As can be seen from the above embodiments of the present disclosure, by the monitor devices 10[1]-10[N] capable of sensing their own poses in the area A1, the area information estimation system 100 and method 300 of the present disclosure not only can overcome the problem generated in situations of crowding and/or occlusion to perform the crowd counting in a wide range area, but also allow the monitor devices 10[1]-10[N] to move in the area A1 without calibration. In addition, by the monitor devices 10[1]-10[N] predicting the 2D density maps 2DM1-2DMN according to the images IMG1-IMGN of the area A1 and the processing device 20 fusing the outputs of the monitor devices 10[1]-10[N] to generate the 3D density map 3DM and calculate the number of the target objects B1-BM, the area information estimation system 100 and method 300 of the present disclosure has advantage of sharing the heavy computational burden, etc.

The disclosed methods, may take the form of a program code (i.e., executable instructions) embodied in tangible media, such as floppy diskettes, CD-ROMS, hard drives, or any other transitory or non-transitory machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. An area information estimation method, applicable to an area information estimation system comprising a processing device and a plurality of monitor devices, and comprising:
by the plurality of monitor devices, capturing a plurality of images of an area from different views;
by the plurality of monitor devices, generating a plurality of two-dimensional (2D) density maps of at least one target object in the area according to the plurality of images;
by the processing device, generating a three-dimensional (3D) density map according to the plurality of 2D density maps; and
by the processing device, calculating a number of the at least one target object according to the 3D density map.

2. The area information estimation method of claim 1, wherein generating the plurality of 2D density maps of the at least one target object according to the plurality of images comprises:
by the plurality of monitor devices, transforming the plurality of images into the plurality of 2D density maps by using a 2D neural network model.

3. The area information estimation method of claim 1, further comprising:
by the plurality of monitor devices, providing a plurality of image capturing data corresponding to the plurality of images to the processing device.

4. The area information estimation method of claim 3, wherein when at least one of the plurality of monitor devices is moved, the area information estimation method further comprises:
by the at least one of the plurality of monitor devices, using a visual-based localization technology to calculate at least one device pose information, so as to generate at least one of the plurality of image capturing data.

5. The area information estimation method of claim 3, further comprising:
by the plurality of monitor devices, accessing a plurality of camera parameter information of a plurality of cameras of the plurality of monitor devices as the plurality of image capturing data.

6. The area information estimation method of claim 1, wherein generating the 3D density map according to the plurality of 2D density maps comprises:
generating an aggregated volume model by projecting the plurality of 2D density maps according to a plurality of image capturing data; and
generating the 3D density map according to the aggregated volume model.

7. The area information estimation method of claim 6, wherein generating the aggregated volume model by projecting the plurality of 2D density maps according to the plurality of image capturing data comprises:
calculating a position of at least one characteristic pixel point of the plurality of 2D density maps in the aggregated volume model according to the plurality of image capturing data, so as to form at least one voxel point of the aggregated volume model.

8. The area information estimation method of claim 6, wherein generating the 3D density map according to the aggregated volume model comprises:
transforming the aggregated volume model into the 3D density map by using a 3D neural network model.

9. An area information estimation system, comprising:
a plurality of monitor devices, configured to be arranged in an area, configured to capture a plurality of images of the area from different views, and configured to generate a plurality of two-dimensional (2D) density maps of at least one target object in the area according to the plurality of images; and
a processing device, coupled to the plurality of monitor devices, configured to generate a three-dimensional (3D) density map according to the plurality of 2D density maps, and configured to calculate a number of the at least one target object according to the 3D density map.

10. The area information estimation system of claim 9, wherein the plurality of monitor devices each comprises:
a camera, configured to capture a corresponding one of the plurality of images; and
a processor, coupled to the camera, and configured to transform the corresponding one of the plurality of images into a corresponding one of the plurality of 2D density maps by using a 2D neural network model.

11. The area information estimation system of claim 10, wherein the 2D neural network model is a convolutional neural network.

12. The area information estimation system of claim 9, wherein the plurality of monitor devices are configured to provide a plurality of image capturing data corresponding to the plurality of images to the processing device.

13. The area information estimation system of claim 12, wherein the plurality of monitor devices each comprises:
a processor, configured to calculate device pose information by a visual-based localization technology when a corresponding one of the plurality of monitor devices is moved, and configured to generates a corresponding one of the plurality of image capturing data according to the device pose information.

14. The area information estimation system of claim 12, wherein the plurality of monitor devices each comprises:
a camera, configured to capture a corresponding one of the plurality of images;
a storage, configured to store camera parameter information of the camera; and
a processor, coupled to the camera and the storage, and configured to access the camera parameter information as a corresponding one of the plurality of image capturing data.

15. The area information estimation system of claim 14, wherein the camera parameter information comprises camera intrinsic, camera extrinsic and distortion coefficients.

16. The area information estimation system of claim 9, wherein the processing device is configured to generate an aggregated volume model by projecting the plurality of 2D density maps according to a plurality of image capturing data, and is configured to generate the 3D density map according to the aggregated volume model.

17. The area information estimation system of claim 16, wherein the processing device is configured to calculate a position of at least one characteristic pixel point of the plurality of 2D density maps in the aggregated volume model according to the plurality of image capturing data, so as to form at least one voxel point of the aggregated volume model.

18. The area information estimation system of claim 16, wherein the processing device is configured to transform the aggregated volume model into the 3D density map by using a 3D neural network model.

19. The area information estimation system of claim 18, wherein the 3D neural network model is a convolutional neural network.

20. A non-transitory computer readable storage medium with a computer program to execute an area information estimation method applicable to an area information estimation system comprising a processing device and a plurality of monitor devices, wherein the area information estimation method comprises:
by the plurality of monitor devices, capturing a plurality of images of an area from different views;
by the plurality of monitor devices, generating a plurality of two-dimensional (2D) density maps of at least one target object in the area according to the plurality of images;
by the processing device, generating a three-dimensional (3D) density map according to the plurality of 2D density maps; and
by the processing device, calculating a number of the at least one target object according to the 3D density map.
